(19) United States
(12) Patent Application Publication
(10) Pub. No.: US 2026/0260573 A1
(43) Pub. Date: Sep. 3, 2026

(54) AUTOMATED CUSTOMIZED SECURITY TRAINING

(71) Applicant: Abnormal AI, Inc., Las Vegas, NV (US)

(72) Inventors: Sanjay Jeyakumar, El Cerrito, CA (US); Evan Reiser, San Francisco, CA (US); Abhijit Bagri, Atlanta, GA (US); Alexander J. Manes, New York, NY (US); Edwin Maljames, Bangalore (IN); Rahul R Nair, Bangalore (IN); Vishnu S Sengar, Bangalore (IN); Yashvi Ramanuj, Bangalore (IN); Arghya Saha, Bangalore (IN); Ankit Garg, Redwood City, CA (US); Michael R Britton, Celina, TX (US); Miguel Luis G Ablaza, Aldie, VA (US)

(21) Appl. No.: 19/078,020

(22) Filed: Mar. 12, 2025

Related U.S. Application Data
(60) Provisional application No. 63/765,023, filed on Feb. 28, 2025.

(51) Int. Cl. G09B 7/02; G06F 40/186; G06F 40/40

(52) U.S. Cl. CPC G09B 7/02; G06F 40/186; G06F 40/40

(57) ABSTRACT

Information associated with a security test target recipient is obtained. Based on the obtained information, a large language model is used to customize content of a security test for the security test target recipient. The security test with the customized content is provided to the security test target recipient. A recipient behavior to the security test is tracked. Based on the recipient behavior, responsive content to the security test target recipient is provided.

### CROSS REFERENCE TO OTHER APPLICATIONS

This application claims priority to U.S. Provisional Patent Application No. 63/765,023 entitled AUTOMATED CUSTOMIZED SECURITY TRAINING filed Feb. 28, 2025, which is incorporated herein by reference for all purposes.

### BACKGROUND OF THE INVENTION

Organizations face cyber threats aimed at their information systems, networks, devices, and data. To help address these attacks, many organizations provide security training to their employees. Traditional training methods typically follow a static, one-size-fits-all approach. The training is often designed to be broadly applicable, and employees in different roles and even at different companies may undergo the same or similar training, which is commonly conducted on a set schedule, such as annually or semi-annually. Moreover, when the training is motivated by compliance or regulatory requirements, an emphasis may be placed on completing the training rather than on ensuring meaningful behavioral change. Increasingly, organizations are faced with a growing number of sophisticated cyber threats, intensified by the use of advanced technologies like generative artificial intelligence (AI) by malicious actors. Therefore, there is a need for an automated solution for personalized and adaptable security training that is capable of addressing the specific security needs of organizations and their different employees.

### BRIEF DESCRIPTION OF THE DRAWINGS

Various embodiments of the invention are disclosed in the following detailed description and the accompanying drawings.

FIG. 1 is a block diagram illustrating an embodiment of a system for providing customized security awareness training.

FIG. 2 is a block diagram illustrating an embodiment of a security awareness training service for providing customized security awareness training.

FIG. 3 is a flow chart illustrating an embodiment of a process for automatically providing customized security awareness training.

FIG. 4 is a flow chart illustrating an embodiment of a process for providing customized security awareness training.

FIG. 5 is a flow chart illustrating an embodiment of a process for creating customized security awareness training simulations.

FIG. 6 is a flow chart illustrating an embodiment of a process for providing a customized security awareness training to a target recipient.

FIG. 7 is a flow chart illustrating an embodiment of a process for providing a follow-up security awareness training session for a target recipient.

FIG. 8 is a flow chart illustrating an embodiment of a process for generating a customized security awareness training video for a target recipient.

FIG. 9 is a functional diagram illustrating a programmed computer system for providing customized security awareness training.

FIG. 10 is an example of a generated email threat message provided to a target recipient for security awareness training.

FIG. 11 is an example of a generated email threat message provided to a target recipient for security awareness training.

FIG. 12 is an example of a generated message that includes responsive content based on the behavior of a target recipient to security awareness training.

FIG. 13 is an example of an example message from a target recipient to initiate a follow-up interactive training session in response to security awareness training.

FIG. 14 is an example of a generated message that includes responsive follow-up content to answer a recipient request as part of a follow-up training session.

FIG. 15 is an example of a user interface timeline view for displaying security awareness training results.

FIG. 16 is an example of a user interface dashboard view for displaying security awareness training results.

FIG. 17 is an example of a generated personalized security training video provided to a target recipient for security awareness training.

FIG. 18 is an example of a generated personalized security video training provided to a target recipient for security awareness training.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automated security training that is customized and adapted for intended recipients is disclosed. Using the disclosed techniques and systems, security training solutions can be provided that address the unique needs of individuals, including solutions that automatically adapt to a user's security profile, risks, and threats. For example, for a specific employee of an organization, multiple different unique and separate security awareness training scenarios can be generated. The generated scenarios can include a video training session, a simulated cyber-threat scenario, or other customized security training content. For example, the generated security awareness training scenarios can be customized to utilize a specific tone and to include custom imagery such as specific corporate logos, backgrounds, or company personnel, among other configured customizations. Moreover, the generated content can address the unique needs of a user by adapting the content based on the unique profile of the target user. For example, a simulated cyber-threat scenario can utilize the risk and behavior profile of the target user including adapting the generated content for the user's specific role and team within an organization. The generated content can further be based on past security threats for the target user (or users with similar profiles). In various embodiments, generated training scenarios can include simulated attacks based on particularly relevant threat vectors.

In some embodiments, the disclosed security training solutions can track and/or monitor a user's progress for a generated security awareness training scenario. For example, for a training video, the user's progress in the video and interaction with a video can be tracked including portions that are repeated or skipped. Similarly, for an email threat scenario, the user's actions with a simulated email-based security threat, such as a phishing attack, can be tracked including whether the user opens the email, the time spent reading the email, whether the user clicks on any links, whether the user opens any attachments included in the email, and/or whether the email was forwarded, replied to, saved, or another email action was performed. Based on the user's interaction with the generated security awareness training scenario, a customized response can be provided. In the event the user passes the security test, the response can include, for example, praise for passing the simulated threat. In the event the user fails the security threat, the response can include, for example, instructions on why the user's action created a security risk, tips and/or hints for identifying the risk in the future, and/or other training content based on the user's response. As another example, the response can be generated training content including personalized video content that walks the user through the exact threat (such as an email security threat) and trains the user to identify the associated threat vectors and the appropriate action to take when a threat vector has been identified.

In various embodiments, the disclosed security training solutions can provide for interactive follow-up training. For example, in response to a security response to a generated security awareness training scenario, the user can further interact with the response, such as via email or a chat bot, and request additional tips or suggestions and/or ask follow-up questions. Example questions a user can ask include questions on how to identify security risks and how to respond to identified risks. The disclosed security training solutions can generate follow-up responses that address the user's response. In some embodiments, the follow-up answers utilize an email format, a video format, a web-based format, an interactive simulation scenario format, or another appropriate format for conveying the appropriate answers to the user's questions. Moreover, the content from the follow-up training including user questions and generated responses can be further used for generating future security awareness training content and scenarios.

In some embodiments, information associated with a security test target recipient is obtained. For example, information related to an employee, such as the employee's security risk profile, job description, and/or team within an organization, is obtained. The information can include past user behavior such as email behavior including encountered security threats and past security training results. In some embodiments, based on the obtained information, a large language model is used to customize content of a security test for the security test target recipient. For example, a customized security test is automatically generated by providing the large language model with a generative artificial intelligence (AI) prompt. In some embodiments, the content for the prompt can include one or more templates associated with security tests, the obtained information associated with the target recipient, configuration parameters for the security test, and/or a description of the desired output, among other prompt details. Using the large language model, a security test with customized content can be generated.

In some embodiments, the security test with the customized content is provided to the security test target recipient. For example, the target recipient is provided with the generated security test to simulate a security threat. As one example, the test may be a simulated email phishing threat that is directed to the user's email inbox. In some embodiments, a recipient behavior to the security test is tracked. For example, the recipient's interaction with the generated security test email can be tracked such as when and if the user reads the email, how much time is spent reading the email, whether the email is saved, whether the email is forwarded, whether the recipient responds to the email, whether the user clicks on any links embedded in the email and which links are clicked on, and/or whether the user interacts with any attachments included in the email and which attachments have actions performed on them, among other actions. As part of tracking the user's behavior, tracked actions can include a timestamp among other tracking data. In some embodiments, based on the recipient behavior, responsive content is provided to the security test target recipient. For example, in response to the user's behavior, such as correctly identifying the security threat or falling for the security threat, a response analyzing the recipient's behavior is automatically generated for the recipient. The responsive content can include training material such as steps to avoid future security threats, a description on the type of security threat encountered, how to identify the threat, and how to properly respond to the threat, among other content. In various embodiments, the responsive content is automatically generated based on the recipient's behavior. In some embodiments, certain configuration parameters such as tone, specific examples or content, or other configuration parameters can be specified for use in generating the responsive content.

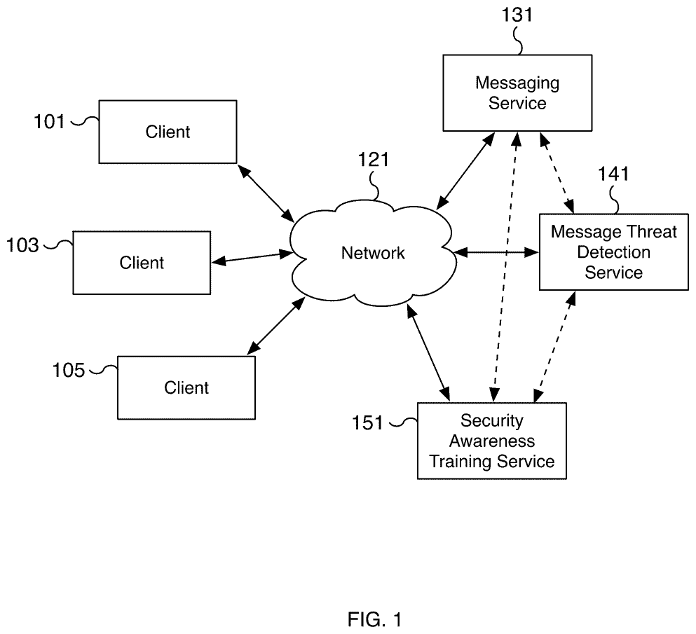

FIG. 1 is a block diagram illustrating an embodiment of a system for providing customized security awareness training. Using the disclosed techniques and systems, security training solutions can be provided that address the unique needs of individuals, including solutions that automatically adapt to a user's security profile, risks, and threats. The generated security awareness training can include training videos, simulated security threats, and training content based on security training simulations. In the example shown, messages provided via messaging service 131 for clients such as clients 101, 103, and 105 are analyzed by message threat detection service 141 for security threats. Clients 101, 103, and 105 are communicatively connected to messaging service 131, message threat detection service 141, and/or security awareness training service 151 via network 121. Similarly, messaging service 131, message threat detection service 141, and security awareness training service 151 are communicatively connected to one another via network 121. Network 121 can be a public or private network. In some embodiments, network 121 is a public network such as the Internet. In various embodiments, clients such as clients 101, 103, and/or 105 can access messaging service 131 to fulfill messaging requirements such as sending and receiving messages. Message threat detection service 141 monitors and analyzes the messages, identifying and mitigating security threats. Security awareness training service 151 provides security training services to targeted recipients such as users of clients 101, 103, and/or 105. The provided training services include training services based on generated written and/or video content, security training simulations, and/or interactive training materials. As disclosed herein, the security training content utilized by security awareness training service 151 can be customized to the target recipient and automatically generated. Although the security training solution of FIG. 1 is described with respect to messages, such as email or chat messages, the solution is further applicable for other information technology domains, such as user account management, among others.

In some embodiments, clients 101, 103, and 105 are each a network client device for interfacing with messaging service 131, message threat detection service 141, and/or security awareness training service 151. For example, clients 101, 103, and/or 105 can correspond to users of an organization configured to access a messaging service such as an email service offered by messaging service 131. As another example, clients 101, 103, and/or 105 can correspond to information security personnel or other users with authorized security credentials that utilize message threat detection service 141 for performing security responsibilities, including managing threat detection for supported messaging services such as messaging service 131. For example, clients corresponding to an authorized security administrator can configure message threat detection service 141 and/or access threat detection reports from message threat detection service 141. In various embodiments, clients 101, 103, and/or 105 can correspond to target recipients of security training services provided by security awareness training service 151, such as employees of an organization that receive security training including personalized video training and interactive training using simulated threats. Clients 101, 103, and/or 105 can also correspond to administrators for configuring, managing, and reviewing the security training services provided for targeted recipients. For example, in particular embodiments, security administrators via clients 101, 103, and/or 105 can access a security training dashboard for reviewing the status of security training campaigns provided to managed users.

In some embodiments, messaging service 131 is a cloud-based platform for providing messaging services. Examples of messaging services can include email, group or workplace chat or communication services, text and/or multimedia messaging services, and instant messaging services, among others. Although only a single messaging service 131 is shown in FIG. 1, multiple messaging services can be supported, such as different email services and/or one or more email services along with other messaging services, such as a group chat service. In various embodiments, messages sent via messaging service 131 are analyzed for potential threats by message threat detection service 141. In some embodiments, messaging service 131 may be used to deploy training solutions generated by security awareness training service 151, such as simulated threats related to messaging service 131.

In some embodiments, message threat detection service 141 is a threat detection system for detecting and mitigating threats associated with messaging service 131. For example, message threat detection service 141 can ingest messages sent and/or received by messaging service 131. In some embodiments, the messages are retrieved from messaging service 131 and/or by directly accessing the messages from clients. The monitored messages can be analyzed, assigned threat scores or risk profiles, and then the identified threats can be mitigated. In some embodiments, the analyzed threats are tracked such as with one or more threat logs. For example, user risk profiles can be tracked based on a threat log and analyzed threat data can be used to generate security threat training simulations. In some embodiments, message threat detection service 141 interfaces with security awareness training service 151 to help serve training simulations. For example, message threat detection service 141 can be configured to allow simulated threats generated by security awareness training service 151 to bypass its threat detection services thereby allowing a targeted recipient to receive the simulated threat as part of a training program.

In various embodiments, message threat detection service 141 can further provide reports on threat detection results to users such as security personnel. For example, message threat detection service 141 can provide automated reports including notifications and/or email reports based on detected security threats and/or tracked user interactions with security threats. In some embodiments, message threat detection service 141 provides a dashboard such as an interactive dashboard for reviewing and managing detected threats identified in analyzed messages.

In some embodiments, security awareness training service 151 is a service for providing security training to targeted recipients. The provided training utilizes automatically and customized generated security training content including written, interactive, video, and/or mixed media content. For example, training videos covering security training material can be automatically generated for a specific user, group of users, organization, or another targeted recipient or group of recipients. Similarly, security training simulations such as simulated email threats can be generated and deployed to targeted recipients based on the security training needs of the actual recipients. As part of the training solution, responsive reports can be generated for a targeted recipient as feedback to how the recipient responded to a simulated threat scenario. In various embodiments, security awareness training service 151 can further provide interactive training sessions such as in response to a generated report. For example, the interactive training session can include providing generated and customized answers to received questions from a targeted recipient related to a performed threat simulation.

In various embodiments, security awareness training service 151 can further provide reports on security awareness training results to users such as security personnel. For example, security awareness training service 151 can provide automated reports including notifications and/or email reports based on passed and failed security training scenarios, completed training sessions, scheduled training, and/or other training related programs and results. In some embodiments, security awareness training service 151 provides a dashboard such as an interactive dashboard for reviewing and managing security awareness training for different services such as messaging services. The provided information can include progress information on a recipient undergoing a training simulation such as when the recipient received a simulated threat email, whether and when the recipient opened the email, whether and when the recipient clicked on a simulated malware link embedded in the email, and whether and when the recipient reviewed a responsive report on the recipient's interactions with the simulated threat email, among other actions and events.

Although single instances of some components have been shown to simplify the diagram of FIG. 1, additional instances of any of the components shown in FIG. 1 may exist. For example, messaging service 131 may be implemented by one or more messaging service servers, message threat detection service 141 may be implemented by one or more message threat detection service servers, and security awareness training service 151 may be implemented by one or more security awareness training service servers. In some embodiments, some of the servers and their functionalities may be merged. For example, some servers may perform tasks related to both message threat detection service 141 and security awareness training service 151. Additionally, clients 101, 103, and 105 are example client devices. Although three clients are shown (clients 101, 103, and 105), many more additional clients can exist. Similarly, although only a single messaging service is shown (messaging service 131), many more messaging and other IT services such as account management services, file sharing services, chat services, etc. can be supported and monitored by a threat detection service such as message threat detection service 141. Additionally, in various embodiments, security training can be provided by security awareness training service 151 for services other than messaging services. In some embodiments, security awareness training service 151 may utilize large language models such as via an internal and/or third-party large language model service that is not shown. In some embodiments, components not shown in FIG. 1 may also exist and/or the network configuration of the included components may differ from what is shown.

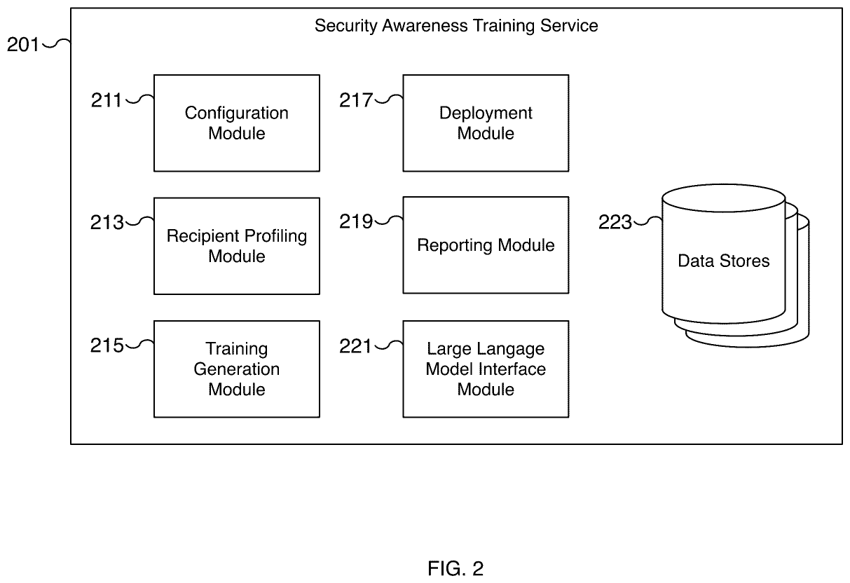

FIG. 2 is a block diagram illustrating an embodiment of a security awareness training service for providing customized security awareness training. In the example shown, security awareness training service 201 includes configuration module 211, recipient profiling module 213, training generation module 215, deployment module 217, reporting module 219, large language model (LLM) interface module 221, and data stores 223. Using security awareness training service 201, customized security awareness training can be provided to targeted recipients. The customized security awareness training can be generated automatically based on configurated requirements including based on a target recipient for the training. For example, security awareness training content can be created based on the risk profile and needs of a target recipient, the requirements set by an organization, and/or other configurable settings. Moreover, the training content can be generated and provided based on a set schedule, such as annually, based on demand, based on need, and/or based on compliance requirements, among other scheduling parameters. In some embodiments, the security training content is generated as least in part by using generative artificial intelligence (AI) services that utilize one or more large language models. Once deployed to the target recipient, the results of the training are provided for review, such as via reports and/or interactive dashboards, allowing security personnel such as compliance officers to audit the status of security awareness training.

In some embodiments, security awareness training service 201 is security awareness training service 151 of FIG. 1. In some embodiments, security awareness training service 201 integrates with and utilizes threat detection results from a message threat detection service such as message threat detection service 141 of FIG. 1, and the generated security training content can be deployed by security awareness training service 201 using a messaging service such as messaging service 131 of FIG. 1. In some embodiments, recipients that receive customized security training and/or users that manage the customized security training correspond to clients such as clients 101, 103, and/or 105 of FIG. 1.

In some embodiments, configuration module 211 is a processing module for configuring a security awareness training service including for configuring the generation and deployment of customized security awareness training. For example, configuration module 211 can process configuration parameters provided by security personnel to configure the tone and content used in customized security training. Examples of configurable content can include imagery, branding assets, and terminology used by an organization. In some embodiments, the configuration provided includes identifying intended target recipients and the frequency and type of training they require. For example, security personnel can configure that members of an organization's financial team receive monthly training on email threats designed to reveal confidential financial data and that all managers receive bi-yearly training on email threats designed to share employment hiring data. In some embodiments, the configuration parameters are received via a web interface such as a web application or web service.

In some embodiments, recipient profiling module 213 is a processing module for obtaining information on a recipient that is used for generating customized training content. For example, recipient profiling module 213 can be configured to interface with different services such as services that organize employee data including job description, responsibilities, and access privileges. As another example, recipient profiling module 213 can interface with threat management services to retrieve a security profile of a recipient such as a risk profile, a list of past encountered security threats, and a list of interactions and results from encountered security threats. In various embodiments, recipient profiling module 213 can retrieve data on a target recipient that allows security training content to be customized for the recipient.

In some embodiments, training generation module 215 is a processing module for generating customized security training content. Training generation module 215 can utilize configuration settings and recipient information including by obtaining the needed information from other modules or sources such as configuration module 211, recipient profiling module 213, and/or data stores 223. In some embodiments, training generation module 215 utilizes large language model (LLM) interface module 221 to generate the customized training content based on one or more created generative artificial intelligence (AI) prompts and one or more selected training content templates. Using training generation module 215, security content such as training videos, interaction training sessions, and simulated security threats, among other training content can be generated that target a particular recipient. The generated security content can be provided to the target recipient via deployment module 217.

In some embodiments, deployment module 217 is a processing module for deploying generated security training. For example, a security awareness training video can be deployed to a target recipient by deployment module 217. Similarly, deployment module 217 can deploy a security threat simulation to a target recipient. In some embodiments, deployment module 217 interfaces with other services such as messaging services or content hosting services to deploy the training content. In some embodiments, the deployed training content is an interactive training session such as an interactive follow-up training session that includes back-and-forth responses between the recipient and security awareness training service 201. For certain training content, such as for certain interactive sessions, deployment module 217 can interface with other modules of security awareness training service 201 such as training generation module 215 to generate responses that are responsive to a recipient's request.

In some embodiments, reporting module 219 is a processing module for providing reporting data on security awareness training provided by security awareness training service 201. In various embodiments, the provided reporting data can include different reports such as training reports and threat simulations reports. Training reports can include detailed training data such as for employees. For example, the training data can include completion rates, course performance, and compliance adherence data. The training data can be used for regulatory reporting and internal audits. Example threat simulation reports can include comprehensive data on threat simulation results including response rates, types of simulated attacks, and overall organizational resilience. The provided threat simulation reports can be used to assess and improve security awareness. In some embodiments, reporting module 219 provides more granular details including real-time reporting on training while a user is undergoing specific security training such as a threat simulation. For example, reporting module 219 can display the progress and performed actions of a user for a particular training simulation, such as whether a user opened a simulated email threat, clicked on a malicious link embedded in the email, and/or reported the simulated email threat.

In some embodiments, large language model (LLM) interface module 221 is a processing module for interfacing with LLM services. For example, an LLM can be queried with an LLM prompt using LLM interface module 221. In various embodiments, LLM interface module 221 allows security awareness training service 201 and its components, such as training generation module 215 and reporting module 219, to utilize LLM-based results such as for the synthesis and generation of security training content and reports. Using LLM interface module 221, training content can be generated that enforces a specific tone and utilizes specified terminology and other configuration settings. For example, training generation module 215 can generate a security awareness training video that uses a specific business tone, unique terminology commonly used or promoted by an organization or industry, and further reference actual personnel employed by an organization such as the Chief Security Officer or a target recipient's manager, co-workers, and/or direct reports. In some embodiments, the generated video can include a generated human-like avatar, such as a narrator, whose image can be based on an actual employee. In some embodiments, LLM interface module 221 can utilize templates such as threat simulation templates, including templates based on past encountered threats, to add custom context when generating a new threat simulation for a target recipient for training purposes.

In some embodiments, data stores 223 are one or more data stores used for providing customized security awareness training. For example, data stores 223 can be used to store data associated with providing security awareness training, such as configuration data for generating customized security training content and the targeted recipients of the content. Other stored data can include threat analysis data including threat logs. In various embodiments, data stores 223 are used for storing security training templates used for generating security awareness training material such as security training simulations. In some embodiments, data stores 223 are used for storing and retrieving results from training provided to target recipients, such as each recipient's completed progress, evaluations on training results, and/or schedule training programs, among other reporting data. In the example shown, data stores 223 can be utilized by the different modules of security awareness training service 201. Although shown as integrated with security awareness training service 201, data stores 223 can include distributed and/or third-party data storage services.

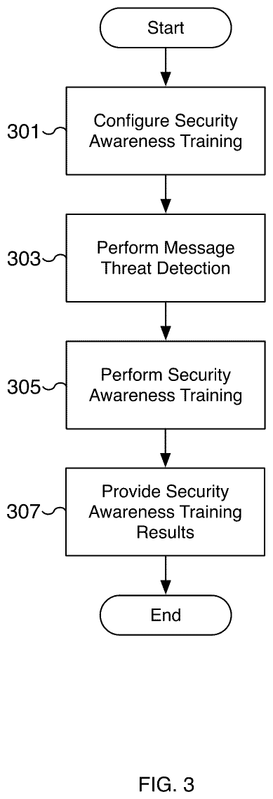

FIG. 3 is a flow chart illustrating an embodiment of a process for automatically providing customized security awareness training. For example, using the process of FIG. 3, a security awareness training service can generate and provide customized security awareness training including customized content for targeted recipients. The generated security awareness content can be adapted to the specific needs of the organization and its targeted recipients. For example, the content can be specialized for an organization such as by using organization's logos, imagery, terminology, and even personnel, among other customizable configurations. As another example, the training content can be directed to specific risks faced by a target recipient, such as based on the target recipient's risk profile, job responsibilities, and past security threat exposure. The generated content can include training videos, simulated training scenarios and simulations, and interactive training sessions, among other training material. In the example shown, the security training is performed with respect to message-based threats as a specific example although the disclosed techniques and systems are applicable for other domains such as user management, file sharing, employee management, etc. In some embodiments, the process of FIG. 3 is performed by a security awareness training service such as security awareness training service 151 of FIG. 1 and/or security awareness training service 201 of FIG. 2.

At 301, security awareness training is configured. For example, the type, format, and properties of security awareness training are configured. In some embodiments, the training can be an interactive training session including with back-and-forth questions and answers such as based on past training material. In some embodiments, the training content can include training videos such as to meet training requirements for the organization's risk and compliance needs. The training content can also include training simulations such as business email compromise, malware, phishing, and QR code attack scenarios designed to help teach recipients of the targeted training how to respond to similar real-life threats. In various embodiments, the content of the training can be configured such as by setting the desired tone of the content, the imagery to include in the content such as corporate logos, terminology, and personnel, the recipients to target for training, and a schedule for providing training, among other configuration settings. For example, the voice and/or image of a chief security officer can be used for training videos allowing an organization to deploy training content customized to the organization's needs and environment. In various embodiments, the configuration can be performed by security administrators, managers, intended recipients, etc. Although these and other settings may be configurable, in some embodiments, the settings can be initially populated automatically. For example, default values can be populated for configurable settings. The default values can be further overridden or revised manually or with additional training.

In some embodiments, the scheduling of the security awareness training is configured. For example, training can be configured based on the risk score assigned to different attacks. The configuration can include varying the frequency based on risk score, varying the difficulty based on risk score, and customizing the types of attacks scheduled based on the recipients. In some embodiments, the configuration allows for automatic scheduling of training, such as scheduling based on a recipient's continued performance during training sessions. For example, when a recipient repeatedly passes training tests, the time between training sessions can increase. However, when the recipient does not pass a training test, the time between training sessions can decrease and/or is reset.

At 303, message threat detection is performed. For example, incoming and outgoing messages are analyzed for threats. Based on the analysis, threats are detected and mitigated. For example, certain messages such as emails can be quarantined or flagged. As another example, potentially malicious links can be rewritten to require additional intervention before they are accessed. In various embodiments, the detected threats are tracked and monitored. For example, threats can be tracked using threat logs and risk profiles can be generated for the recipients of the detected threats. In various embodiments, the message threat detection can be focused on email threats and/or include other messages such as chat messages, group chats, message forums, etc.

At 305, security awareness training is performed. For example, security awareness training is performed by generating customized security training content and providing the training materials to intended recipients. In various embodiments, the training material generated is based on the configurations performed at 301 and can be further generated based on the results from threat detection performed at 303. In some embodiments, the training performed includes video training, interactive training, training simulations, and/or other forms of security awareness training. In various embodiments, the performed training is scheduled at and directed at targeted recipients at 301 based on their security training needs. The training can include interactive training that is responsive to security awareness questions and training requests received from a target recipient.

At 307, security awareness training results are provided. For example, the results of the training performed at 305 are provided to security administrators, managers, targeted recipients, etc. In some embodiments, the results are provided via a dashboard and can include the progress made by the recipients of the security awareness training. For example, the tracked training results can include different events associated with the training such as providing a training simulation, steps taken by a recipient during the simulation, a responsive report based on the simulation results, and follow-up training steps taken after completion of the simulation. A responsive report based on training results can, for example, specify that the recipient has completed watching a training video, passed a quiz testing the recipient's knowledge of the content of a training video, or passed a simulated security threat. In some embodiments, the training results can include a progress status of training requirements such as a list of training requirements, their completion status, and the scheduled and/or expected completion dates of outstanding training requirements. In some embodiments, the training results are used as feedback to update a user's profile including the user's determined risk score(s). For example, in the event a user never completes video training or repeatedly fails certain simulation tests, they can be assessed a higher risk score and be assigned additional security awareness training including additional training simulations.

In some embodiments, the process of FIG. 3 is executed and repeated and/or can run continuously once initiated. Moreover, some of the steps of the process of FIG. 3 may also be run in parallel. For example, once started, threat detection performed at 303 can run continuously and until security awareness training configurations are modified by performing the step of 301 again, scheduled security awareness training is performed at 305 and the results are consistently updated and provided at 307.

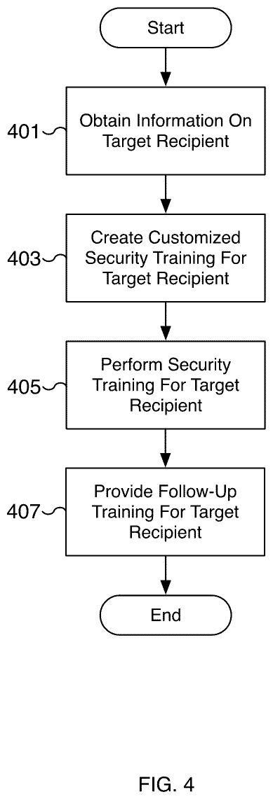

FIG. 4 is a flow chart illustrating an embodiment of a process for providing customized security awareness training. For example, using the process of FIG. 4, content for security awareness training is generated and provided for targeted recipients. The provided security awareness content and training can be automatically generated for and based on specific targeted recipients. Moreover, the provided training can be interactive and include follow-up training such as interactive training sessions to address specific needs raised by a targeted recipient. In some embodiments, the process of FIG. 4 is performed at 303 and/or 305 of FIG. 3 by a security awareness training service such as security awareness training service 151 of FIG. 1 and/or security awareness training service 201 of FIG. 2.

At 401, information on the target recipient is obtained. For example, information on the target recipient, such the user's risk profile, personal attack landscape, access privileges, past security threats encountered, likely future security threats, training history, etc. is obtained. In some embodiments, the obtained information includes attacks the target recipient has been targeted for, attacks an organization of or associated with the target recipient has been targeted for, attacks an industry associated with the target recipient has been targeted for, the general threat landscape, and previous failures including failures of the target recipient, the target recipient's organizations, and the target recipient's associated industries, among other information. In some embodiments, the information also identifies high risk users, such as users classified as VIPs, and administrators over critical or core domains.

In some embodiments, the information obtained at 401 is obtained from multiple different data sources. For example, a user threat log maintained by a threat detection service can be accessed to retrieve the security threats previously encountered by the targeted recipient and how the user responded to those threats. The user's risk profile, job description, access privileges, coworkers and related reporting structure, work schedule, work location, and/or other employee related information can be retrieved from different services such as employee management services, workforce planning services, payroll services, or other services used to manage and maintain information on the target recipient. In various embodiments, the information obtained is related to the security training of the target recipient and/or the target recipient's expected security response to future security threats.

At 403, customized security training is created for the target recipient. For example, using the information obtained at 401, customized security training programs including security awareness training content are generated. In various embodiments, the training content can utilize a template system. For example, an appropriate training template for aspects of security awareness training is selected from a master set of templates, and the selected template is used in connection with the information obtained at 401 to generate customized training content. In some embodiments, the template is selected based on the information obtained at 401, for example, based on the recipient's security risk factors and job description, among other factors. Other factors such as configuration settings including tone and organizational preferences are also used for creating customized security training. The created training can include simulations of security scenarios as well as interactive and non-interactive training sessions such as customized security awareness training videos and interactive Q&A sessions. For example, interactive sessions can take the form of conversational coaching tailored to a user's requests and needs.

At 405, security training is performed for the target recipient. For example, the training content created at 403 is provided to the target recipient. The mode and method of deployment can differ depending on the type of training material. For example, a simulated security threat can be deployed via the recipient's messaging platform. In this manner, the user can be exposed to a simulated security threat such as a simulated phishing attack customized to the user's risk profile. In some embodiments, the training content is video content, and the content can be deployed via a video sharing platform. As another example, the training content can include an interactive training session where the content shared with the target recipient can occur over a messaging service such as an email service, a chat service, or another messaging service. In some embodiments, the security training may include a responsive report to summarize the training the recipient has undergone. The responsive report may include areas for improvement including areas where potential threats were missed and how to avoid the same threats in the future.

At 407, follow-up training is provided for the target recipient. For example, based on the security training performed at 405, the target recipient may engage in follow-up training including remediation training. The training can be an interactive session and can include questions and requests submitted by the target recipient. For example, the recipient can ask how to avoid similar threats in the future and what are identifying signs of these threats. As another example, the recipient may ask to receive additional simulated training scenarios for added training on the same or similar threat. In various embodiments, the responsive security training content is provided in response to the recipient's request. For example, answers are generated and provided in response to questions asked by the recipient, or another simulated training scenario is generated and scheduled. The follow-up security awareness training content can be generated similar to how the initial customized security training is created for the target recipient at 403. In various embodiments, at step 407, where the security training content is a form of follow-up training, the context of the generated security awareness content (such as answers to asked questions or additional training simulation scenarios) can be generated using the additional context of the training generated at 403 and performed at 405.

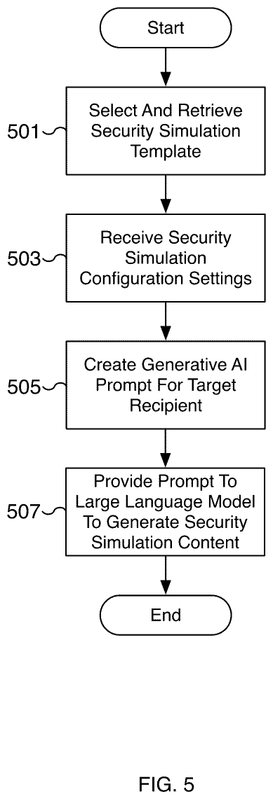

FIG. 5 is a flow chart illustrating an embodiment of a process for creating customized security awareness training simulations. For example, using the process of FIG. 5, content for security awareness training simulations can be generated for targeted recipients based on obtained information on the target recipient. In addition to information based on the targeted recipient, the generated simulation can utilize configured organizational preferences and a selected simulation template. In various embodiments, a training simulation template is selected and generative artificial intelligence (AI) services are used to generate a customized simulation from the template using information on the target recipient and configuration preferences. In some embodiments, the process of FIG. 5 is performed at 303 and/or 305 of FIG. 3 and/or at 403 of FIG. 4 by a security awareness training service such as security awareness training service 151 of FIG. 1 and/or security awareness training service 201 of FIG. 2.

At 501, a security simulation template is selected and retrieved. For example, a template for a training simulation is selected based on selection criteria and received for use in generating a custom training simulation for a target recipient. In various embodiments, the selection criteria used for selecting the template can include information obtained based on the target recipient, such as the recipient's risk profile and training needs, as well as requirements configured for the security awareness training. For example, the selection criteria for a template can include selective attack types based on the recipient's security profile and/or organizational training requirements. In some embodiments, the selection criteria includes information obtained on attacks the target recipient has been targeted for, attacks an organization of or associated with the target recipient has been targeted for, attacks an industry associated with the target recipient has been targeted for, the general threat landscape, and previous failures including failures of the target recipient, the target recipient's organizations, and the target recipient's associated industries, among other information applicable to template selection. In various embodiments, the selected template can include areas and/or fields for customization such as for attack data. For example, a message subject, body, links, and/or attachments can be customized for the selected template. The template selected based on a recipient allows for customization such that a recipient that works in finance may include an attachment that is an invoice, whereas the attachment for a recipient that works in engineering may include a product requirements document and the attachment for a recipient that works in legal may include a nondisclosure agreement. In some embodiments, the templates can be created from past identified real security threats or messages that have had personal identifiable information and other sensitive data removed. For example, a threat previously encountered or received by a user and/or included in the user's inbound and/or outbound emails and email conversions can be analyzed for generating new security threat simulations. By using existing attacks that can be sanitized to remove sensitive information, the generated new simulations accurately reflect the user's actual computing and work environment. The tone of the user's emails can be used to generate a new security threat that matches the same identified tone and is less likely to raise the user's suspicions. In some embodiments, the template may be selected using a large language model such as by providing the model with a prompt that provides the appropriate context to select a template from a collection of templates. For example, a large language model can be prompted to select the template from a set of existing security simulation templates based at least on the target recipient.

At 503, security simulation configuration settings are received. For example, configuration settings for the simulation are received. These settings can include configuration parameters set by an administrator, users, managers, or another user with access for configuring simulation settings. The settings can include specifying a tone or style for the training content. Other settings can include settings specifying terminology for use in the training content such as organizational terms or names. In some embodiments, the settings include imagery or branding assets such as corporate logos, backgrounds, color themes, etc. that are used to customize the training material. The settings may additionally include influence over the types of simulations generated and provided. For example, simulations can be configured to prevent or enable a simulation from impersonating certain users, such as Human Resource department employees, or that include or exclude certain attack types such as QR code based attacks, among other options.

At 505, a generative AI prompt is created for the target recipient. For example, a prompt is created using the information obtained on the recipient and provided to the process of FIG. 5, the template selected and retrieved at 501, and the simulation configuration settings received at 503. The information obtained on the recipient can include attacks the target recipient has been targeted for, attacks an organization of or associated with the target recipient has been targeted for, attacks an industry associated with the target recipient has been targeted for, the general threat landscape, and previous failures including failures of the target recipient, the target recipient's organizations, and the target recipient's associated industries, among other information on the target recipient. For example, a threat previously encountered by a user and/or the user's inbound and/or outbound emails and email conversions can be used as additional context for creating the generative AI prompt. By including the tone of the user's emails, the generated training content is less likely to stand out and raise the user's suspicions. In some embodiments, the created prompt itself uses a prompt template that allows for configuration. For example, a prompt template can be used as a base prompt and then modified to include the proper context to generate the desired security training content. In various embodiments, the created prompt may be a series of prompts and the steps at 505 and/or 507 can be repeated to improve the generated security simulation content.

At 507, the generative AI prompt is provided to a large language model (LLM) to generate security simulation content. For example, the prompt created at 505 is passed to an LLM to generate the training content. In some embodiments, the LLM is accessed via an LLM service and can include multiple different models. Moreover, the LLM service can be a first-party or third-party service. In various embodiments, the inference results of the LLM are a generated security training simulation or security training test that is customized to the target recipient and can be readily deployed. In some embodiments, the process at 507 is an iterative process and may require multiple passes through steps 505 and/or 507 to refine the generative AI prompt and generated security training simulation content. For example, the security content generated by the LLM and based on the template selected at 501 may be provided to the LLM again to complete the generation of the security simulation content. The resulting security simulation content can be heavily tailored to the target recipient and more accurately mimics real security threats than existing solutions.

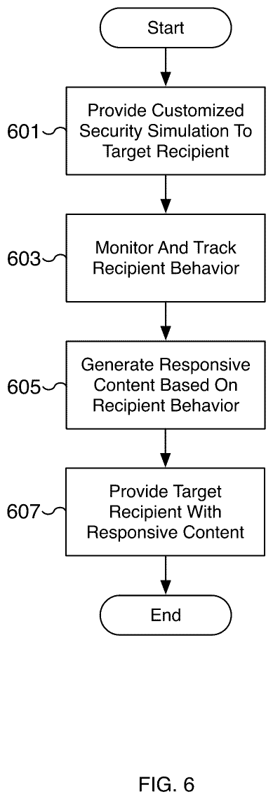

FIG. 6 is a flow chart illustrating an embodiment of a process for providing a customized security awareness training to a target recipient. For example, using the process of FIG. 6, generated security training content can be deployed to a recipient for security training purposes. The generated training content that is provided can include a training simulation such as a simulated phishing or another security threat scenario. As another example, generated training content that is provided can include a training video such as a training video to fulfill organizational security training compliance requirements. In various embodiments, user engagement in the provided training is tracked and a responsive report on the user's participation in the training can be provided. In some embodiments, the process of FIG. 6 is performed at 305 of FIG. 3 and/or at 405 of FIG. 4 by a security awareness training service such as security awareness training service 151 of FIG. 1 and/or security awareness training service 201 of FIG. 2.

At 601, a customized security simulation is provided to the target recipient. For example, a security simulation is provided to the target recipient as part of a security awareness training program. The provided simulation can be a simulated threat scenario such as a security training test that requires the recipient to properly access and respond to the simulated threat. In some embodiments, the simulation is deployed via a messaging service such as via email for email-based security threats. For example, the simulated threat scenario may be a business email compromise, malware, phishing, and QR code, or another type of simulated attack scenario.

At 603, recipient behavior is monitored and tracked. For example, interactions including non-actions by the recipient are monitored and tracked. In some embodiments, the deployment platform is monitored, such as via an application programming interface (API), to track significant events. For example, for a simulated email threat, monitored and tracked recipient behaviors can include actions related to receipt of the simulated email threat, reading the email, accessing a link embedded in the email, accessing an attachment of the email, saving the email, forwarding the email, and/or responding to the email, among other actions. In various embodiments, each action is tracked with a time such as a timestamp and may include an associated time, such as how long a user hovered over a malicious link or the length of time spent reading an email. In some embodiments, the tracked information includes whether or not the action was performed, such as whether or not the recipient responded to the email. In various embodiments, the monitored and tracked recipient data is used to generate responsive reports describing the provided security awareness training and/or to generate additional training scenarios.

At 605, responsive content is generated based on the behavior of the recipient. For example, once the training is complete, a responsive report is generated based on how the recipient navigated the simulated security threat. In various embodiments, the responsive content is dynamically generated, and different responsive content is provided to the recipient based on the actions performed by the recipient in response to the simulated threat. For example, in the event the recipient passed the training, such as by identifying and mitigating the simulated threat, the content provided can congratulate the recipient and reinforce the performed recipient behavior. However, in the event the recipient fails the training, the generated responsive content can walk through the simulated threat to train the recipient on how to identify and mitigate the threat in preparation for future attacks of the same or similar nature. In various embodiments, the responsive content is generated using a large language model with the tracked user behavior provided as additional context. In some embodiments, templates can be used to generate a base form of the responsive context such as to include guidelines or security procedures that must be met. Additional configuration parameters, such as the tone and terminology to use with respect to the generated responsive content, can be specified and enforced.

In some embodiments, the responsive content is a custom video. The custom video can include an evaluation of a threat log or related threat encounter. In some embodiments, the responsive content is personalized for the recipient, and may include specifics of the recipient such as their name, job responsibilities, names and roles of coworkers, and/or areas of risk, etc. For example, the responsive content can walk the recipient through the email threat, flag the parts that were problematic, and suggest aspects to watch out for.

At 607, the target recipient is provided with the generated responsive content. For example, the responsive content generated at 605 is deployed and provided to the target recipient. In some embodiments, the responsive content is provided via a messaging service although other mediums are appropriate as well. For example, in some embodiments, a responsive report is provided via a web service such as a chat service or interactive dashboard. In some embodiments, once the recipient receives the generated responsive content, the recipient can initiate follow-up requests based on the training and/or the generated responsive content.

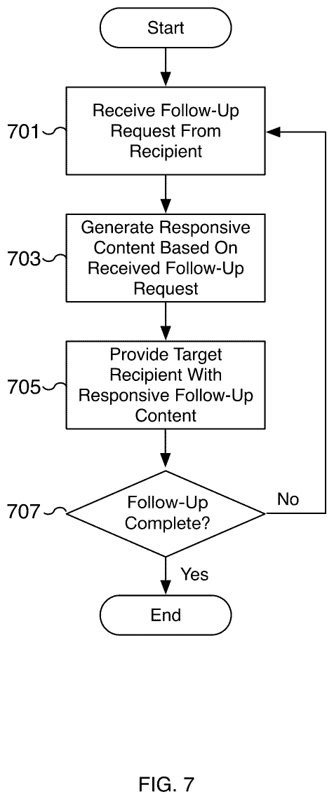

FIG. 7 is a flow chart illustrating an embodiment of a process for providing a follow-up security awareness training for a target recipient. For example, using the process of FIG. 7, follow-up training such as an interactive training session can be provided that reinforces previously provided security training. In various embodiments, the context of the follow-up training can include the previously provided training including the performance and results from the completed training. As part of the follow-up security awareness training, the target recipient can ask follow-up questions and responsive answers are generated and provided to the recipient. In some embodiments, the process of FIG. 7 is performed at 305 of FIG. 3 and/or at 405 and/or 407 of FIG. 4 by a security awareness training service such as security awareness training service 151 of FIG. 1 and/or security awareness training service 201 of FIG. 2.

At 701, a follow-up request from the recipient is received. For example, a request from a recipient is received in relation to a completed security awareness training. The request can include references to the training such as follow-up questions related to the provided training simulation. For example, the request can include questions on specifics of the simulation such as questions on the threat scenario and/or questions on the response report summarizing the training. In some embodiments, the request initiates an interactive training session that results in a response to the received follow-up request. In various embodiments, no existing or prepared responses exist for the request and a response must be generated in real time.

At 703, responsive content is generated based on the received follow-up request. For example, based on the follow-up request received at 701, a response to the request is automatically generated in real time. In various embodiments, the responsive content is generated using a large language model and a corresponding generative artificial intelligence (AI) prompt. The tone of the response, terminology, and/or substance of the responsive content can be based on configured parameters similar to the generation of the original security awareness training content. In some embodiments, templates may be used at least in part for generating the responsive content. For example, templates such as baseline rules, guidance, and security procedures can exist and are used to ground the generated responsive content. In various embodiments, the responsive content is generated based on the information obtained on the recipient and/or based on the performed security awareness training. In some embodiments, the process for generating responsive content follows the process performed at 405 of FIG. 4 and/or the process of FIG. 5 but with the additional context of the performed security awareness training and the follow-up request received at 701.

At 705, the target recipient is provided with the responsive follow-up content. For example, the responsive content generated at 703 is provided to the target recipient in response to the follow-up request received at 701. In some embodiments, the communication medium used is a messaging service although other mediums such as a group forum, a chat service, a chat agent, a voice call, and/or a video conferencing session, among other mediums may be used as well. In various embodiments, the responsive content is provided to the recipient and may initiate additional follow-up requests from the recipient. For example, the process performed at steps 701, 703, and/or 705 may be part of a portion of a longer interactive training session. In some embodiments, the training session is a remediation session used to reinforce the training goals of the original security awareness training.

At 707, a determination is made whether the follow-up training session is complete. In the event the follow-up training session is not complete, processing loops back to 701 where additional follow-up requests from the recipient are received. In the event the follow-up training session is complete, processing completes. For example, once the recipient actively ends the training session and/or has no additional follow-up questions, the follow-up training session ends and training results are updated. In some embodiments, the training session explicitly requires that a user to take action for the session to be completed. For example, a user may be required to acknowledge completion of the training, finish watching a training video, complete and/or pass a quiz on the training material, etc. If the training is incomplete, in some embodiments, the user will receive reminders, such as repeated reminders of outstanding training requirements.

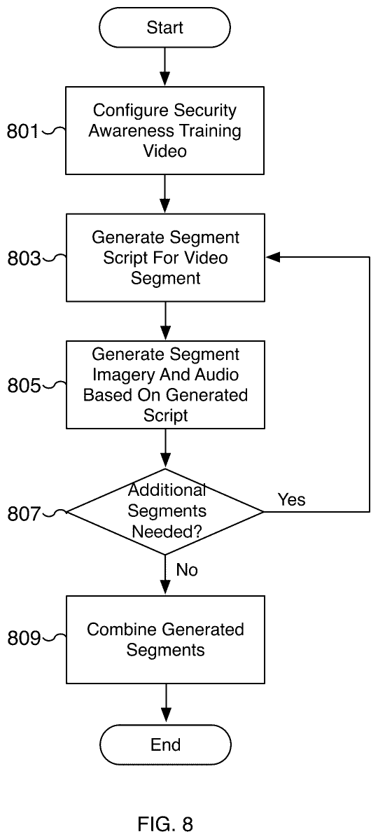

FIG. 8 is a flow chart illustrating an embodiment of a process for generating a customized security awareness training video for a target recipient. For example, using the process of FIG. 8, a personalized training video with a custom script and targeting a particular recipient (or group of recipients) and topic of choice is generated. The generated video can be used for role-based training, for remedial training, as customized responses to a user request or question, and/or for other training purposes. Moreover, the video can utilize a specific tone and specified imagery, terminology, human-like avatars, media assets, and/or other configured preferences to tailor the video for the target recipient. For example, the generated training video content can utilize terminology used by a particular team, group, organization, corporation, and/or industry. In various embodiments, the video is generated in segments that are stitched together and utilizes a large language model to customize the training content. The generated video can be exported for additional processing, editing, and/or use for other training purposes. In some embodiments, the process of FIG. 8 is performed at 305 of FIG. 3 and/or at 403 of FIG. 4 by a security awareness training service such as security awareness training service 151 of FIG. 1 and/or security awareness training service 201 of FIG. 2.

At 801, the security awareness training video is configured. For example, based on the configuration parameters for the desired security awareness training video, the number of segments required by the video is determined and the parameters for generating each segment are determined. In some embodiments, the parameters can include the tone to use for the video, the terminology to use, and the personnel to use or reference in the video. For example, a generated security awareness training video can be personalized for a recipient and the recipient's company. Based on configuration parameters, the generated video can be configured to include the company's logo, imagery or media assets used by the company such as background images, information based on the company's industry, and terminology used by the company and/or its industry. In some embodiments, the generated video is configured to use the likeness of company personnel such as the recipient's manager or the company's chief security officer. For example, the generated video can use the voice and image of the selected personnel to narrate at least portions of the security content script. In various embodiments, different tones can be configured. For some organizations, a more serious tone may be desired whereas other organizations may prefer a more casual or lighthearted tone. In some embodiments, the tone used is based on the tone used to trigger the generation of the video.

At 803, a script for a video segment is generated. For example, a script for a segment of a video is generated using a large language model (LLM) and a generative artificial intelligence (AI) prompt. In some embodiments, a template for the segment is selected and utilized to include a core set of information and/or to address the primary goals of the segment. For example, the goals for a segment may require that three topics are covered and that each topic is repeated at least 3-5 times within a specified time frame. A generative AI prompt can be created that expands on the selected template using the subject matter of the video segment and configuration information obtained at 801, such as the tone, imagery, and target audience. In various embodiments, the generated script is a text-based script and may not yet include imagery. In some embodiments, a template for the prompt is used to create a custom generative AI prompt that addressed the particular needs of the video segment, recipient, and other configuration parameters.

At 805, segment imagery and audio are generated based on the generated script. For example, imagery and audio including synchronized video and audio tracks are generated for the script generated at 803. In various embodiments, the generated imagery and audio can be configured such as for generation parameters for a narrator. For example, the narrator can be configured to utilize an organization's Chief Security Officer. Using a generative AI prompt, the configuration information obtained at 801 and the script generated at 803 can be provided as context to generate the desired video segment to match the generated script. The generated imagery and audio will match the configured tone and include configured imagery such as corporate logos and/or other assets including video, audio, and image assets. In some embodiments, a prompt template is used to create a custom generative AI prompt that addresses the particular needs of the video segment, the target recipient, the generated script, and other configuration parameters. In various embodiments, the generated video can include multiple different audio and/or video tracks, and multiple passes or generative AI passes are used to generate the different tracks and/or to improve on generated tracks. Once generated, the different audio and video tracks can be synchronized to create the video segment.

At 807, a determination is made whether additional segments are needed. In the event one or more additional segments are needed, processing loops back to 803 to generate an additional video segment. In the event no additional segments are needed, processing proceeds to step 809 where the generated segments can be combined.

At 809, the generated segments are combined. For example, the segments generated via steps 803 and/or 805 are combined or stitched together to create a security awareness training video. In some embodiments, segments can be pre-generated and shared across different videos, and step 809 utilizes previously generated segments such as portions of an introduction segment. In various embodiments, the generated video is an interactive and non-linear video and the video segments are combined in a manner that allows for non-linear viewing.

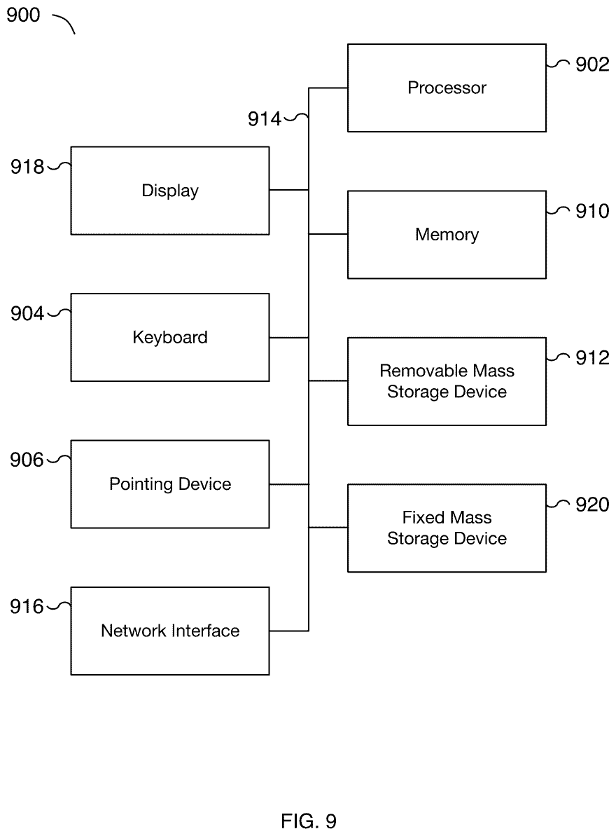

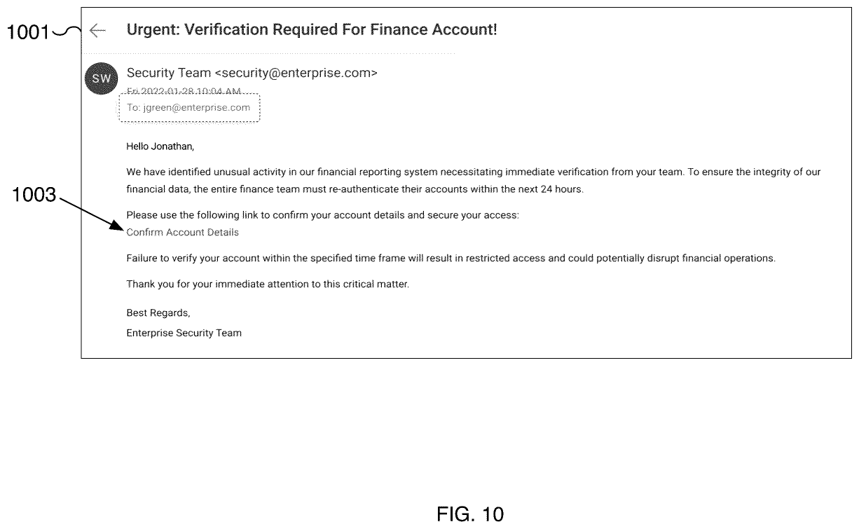

FIG. 9 is a functional diagram illustrating a programmed computer system for providing customized security awareness training. As will be apparent, other computer system architectures and configurations can be utilized for providing customized security awareness training. Examples of computer system 900 include clients 101, 103, and 105 of FIG. 1 and/or one or more computers of messaging service 131 of FIG. 1, message threat detection service 141 of FIG. 1, security awareness training service 151 of FIG. 1, and/or security awareness training service 201 of FIG. 2. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918). In various embodiments, one or more instances of computer system 900 can be used to implement at least portions of the processes of FIGS. 3-8 and the functionality associated with the examples of FIGS. 10-18.

Processor 902 is coupled bi-directionally with memory 910, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data and objects used by the processor 902 to perform its functions (e.g., programmed instructions). For example, memory 910 can include any suitable computer-readable storage media, described below, depending on whether, for example, data access needs to be bi-directional or unidirectional. For example, processor 902 can also directly and very rapidly retrieve and store frequently needed data in a cache memory (not shown).

A removable mass storage device 912 provides additional data storage capacity for the computer system 900, and is coupled either bi-directionally (read/write) or unidirectionally (read only) to processor 902. For example, storage 912 can also include computer-readable media such as magnetic tape, flash memory, PC-CARDS, portable mass storage devices, holographic storage devices, and other storage devices. A fixed mass storage 920 can also, for example, provide additional data storage capacity. The most common example of mass storage 920 is a hard disk drive. Mass storages 912, 920 generally store additional programming instructions, data, and the like that typically are not in active use by the processor 902. It will be appreciated that the information retained within mass storages 912 and 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display monitor 918, a network interface 916, a keyboard 904, and a pointing device 906, as well as an auxiliary input/output device interface, a sound card, speakers, and other subsystems as needed. For example, the pointing device 906 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 9 is but an example of a computer system suitable for use with the various embodiments disclosed herein. Other computer systems suitable for such use can include additional or fewer subsystems. In addition, bus 914 is illustrative of any interconnection scheme serving to link the subsystems. Other computer architectures having different configurations of subsystems can also be utilized.

FIG. 10 is an example of a generated email threat message provided to a target recipient for security awareness training. In the example shown, email message 1001 is generated using a security awareness training service. Email message 1001 is generated based on information obtained on the target recipient and corresponds to a security threat that the recipient requires additional training on. For example, email message 1001 can be generated in response to analyzing inbound and outbound emails of the recipient, identifying activities related to financial account reporting systems accessible by the recipient, and information on the recipient's job description and access privileges. Based on the tone and subject matter of emails sent by the recipient's security team, email message 1001 is generated using the same tone and under the premise that account details require confirmation. In the example shown, email message 1001 is part of a security training threat simulation and includes malicious link 1003 that is a security threat. Activities including opening email message 1001, replying to email message 1001, reading email message 1001, forwarding email message 1001, saving email message 1001, and accessing malicious link 1003, among others, are tracked and monitored. In some embodiments, email message 1001 is generated by security awareness training service 151 of FIG. 1 and/or security awareness training service 201 of FIG. 2 using the processes of FIGS. 3-6.

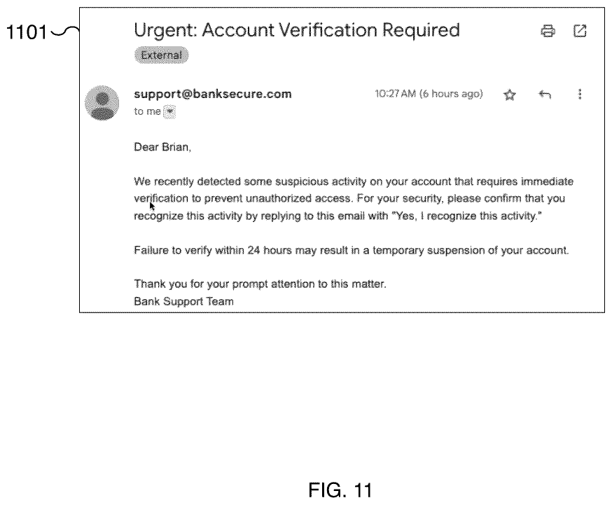

FIG. 11 is an example of a generated email threat message provided to a target recipient for security awareness training. In the example shown, email message 1101 is generated using a security awareness training service. Email message 1101 is generated based on information obtained on the target recipient and corresponds to a security threat that the recipient requires additional training on. For example, email message 1101 can be generated in response to analyzing inbound and outbound emails of the recipient, identifying activities related to an account registered by the recipient, and information on the recipient's job description and access privileges. Based on the tone and subject matter of emails sent by the recipient's bank, email message 1101 is generated using the same tone and under the premise that an account requires verification. Email message 1101 requests that the recipient reply to the email message 1101 with the response “Yes, I recognize this activity.” In the example shown, email message 1101 is part of a security training threat simulation that is a security threat. Activities including opening email message 1101, replying to email message 1101, reading email message 1101, forwarding email message 1101, and saving email message 1101, among others, are tracked and monitored. In some embodiments, email message 1101 is generated by security awareness training service 151 of FIG. 1 and/or security awareness training service 201 of FIG. 2 using the processes of FIGS. 3-6.

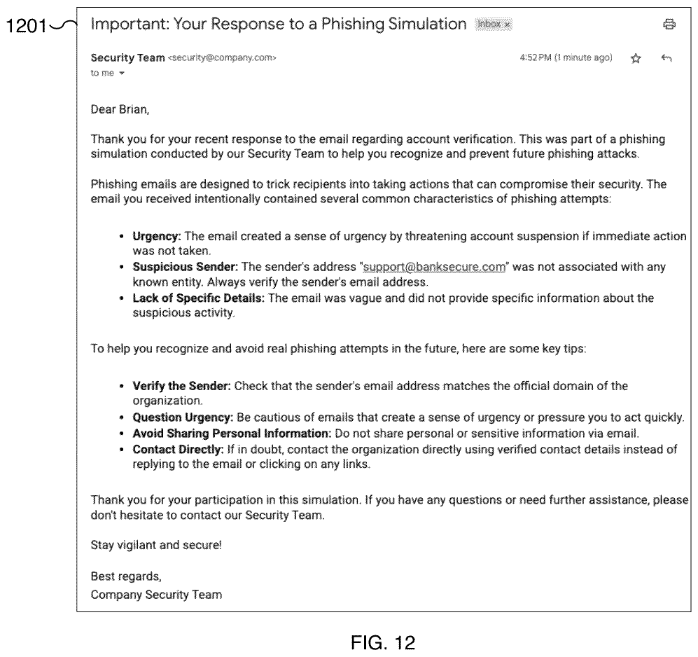

FIG. 12 is an example of a generated message that includes responsive content based on the behavior of a target recipient to security awareness training. In the example shown, responsive email message 1201 is a responsive report generated in response to the target recipient's performance on a personalized security test and specifically on the recipient's interactions with the simulated threat of email message 1101 of FIG. 11. In the scenario shown, the target recipient responded to the simulated email threat of FIG. 11 by replying with the requested phishing message: “Yes, I recognize this activity.” This response by the target recipient (now shown) corresponds to failing the security simulation test. The contents of responsive email message 1201 are personalized to the target recipient and their incorrect behavior (by replying to the simulated email attack). For example, the generated content acknowledges that a simulation test was provided to the recipient for training purposes. The content further describes the purpose of the attack and common characteristics of phishing attempts along with key tips to recognize and avoid similar attacks in the future. In various embodiments, the target recipient can respond to responsive email message 1201 to initiate an interactive follow-up training session. In some embodiments, responsive email message 1201 is generated by security awareness training service 151 of FIG. 1 and/or security awareness training service 201 of FIG. 2 using the processes of FIGS. 3-6.

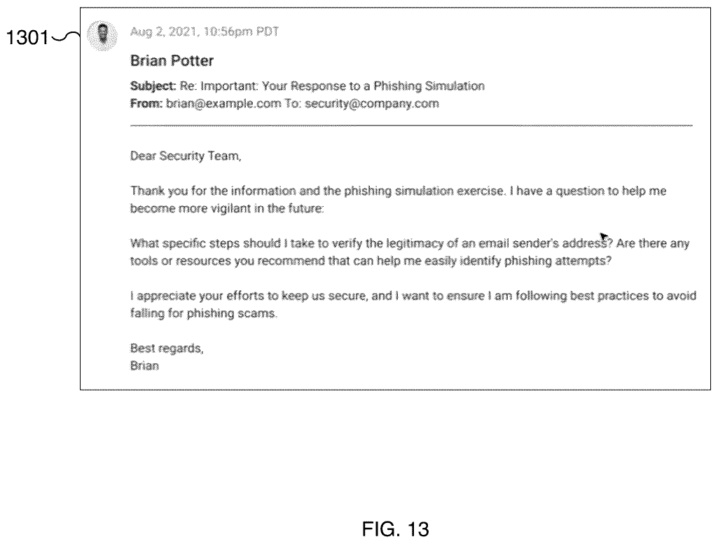

FIG. 13 is an example of an example message from a target recipient to initiate a follow-up interactive training session in response to security awareness training. In the example shown, email request message 1301 is a request sent from a target recipient for follow-up information on security training. The request is based on the context of previously engaged security awareness training by the target recipient and is a reply to responsive email message 1201 of FIG. 12. In the example shown and after failing a phishing security test, email request message 1301 requests information on specific steps to verify the legitimacy of an email sender's address and for recommended tools or resources to identify phishing attempts. Email request message 1301 is received and processed by the disclosed security awareness training service. In various embodiments, email request message 1301 initiates an interactive follow-up training session based on the context of the target recipient's security awareness training. In some embodiments, email request message 1301 is received by security awareness training service 151 of FIG. 1 and/or security awareness training service 201 of FIG. 2 and is managed via the processes of FIGS. 3-6 and/or FIG. 7.

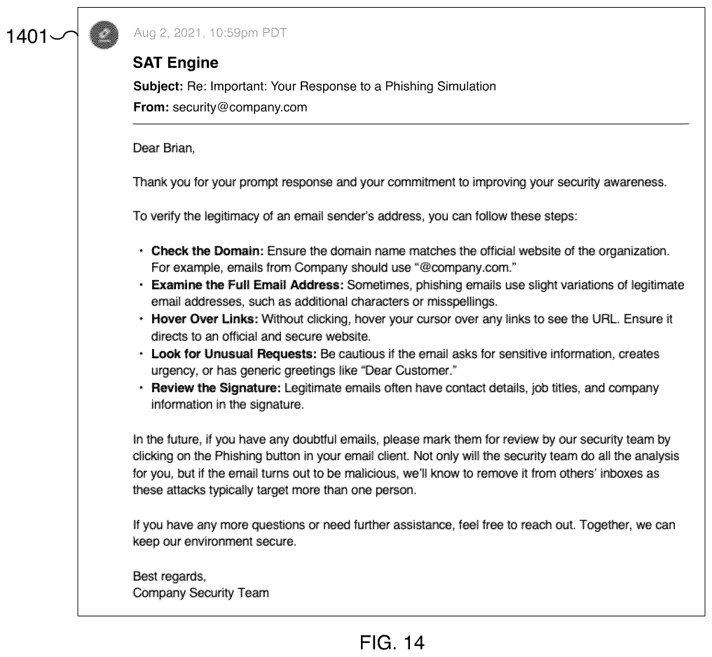

FIG. 14 is an example of a generated message that includes responsive follow-up content to answer a recipient request as part of a follow-up training session. In the example shown, responsive follow-up email message 1401 is a responsive follow-up response with responsive content generated to answer the target recipient's request for follow-up information. In various embodiments, responsive follow-up email message 1401 is a response to email request message 1301 of FIG. 13. The personalized content of responsive follow-up email message 1401 is generated using the context of the recipient's security awareness training and the content of the recipient's follow-up request asking for additional information on phishing attacks. The contents of responsive follow-up email message 1401 are personalized and generated based on the target recipient, the tracked incorrect behavior of the recipient by replying to the simulated email attack, and to answer the questions raised by email request message 1301 of FIG. 13. For example, the generated content of responsive follow-up email message 1401 includes steps explaining to the recipient the steps to follow for verifying the legitimacy of the email sender's address and for suggestions on how to respond to questionable emails. In some embodiments, responsive follow-up email message 1401 is generated by security awareness training service 151 of FIG. 1 and/or security awareness training service 201 of FIG. 2 using the processes of FIGS. 3-6 and/or FIG. 7.

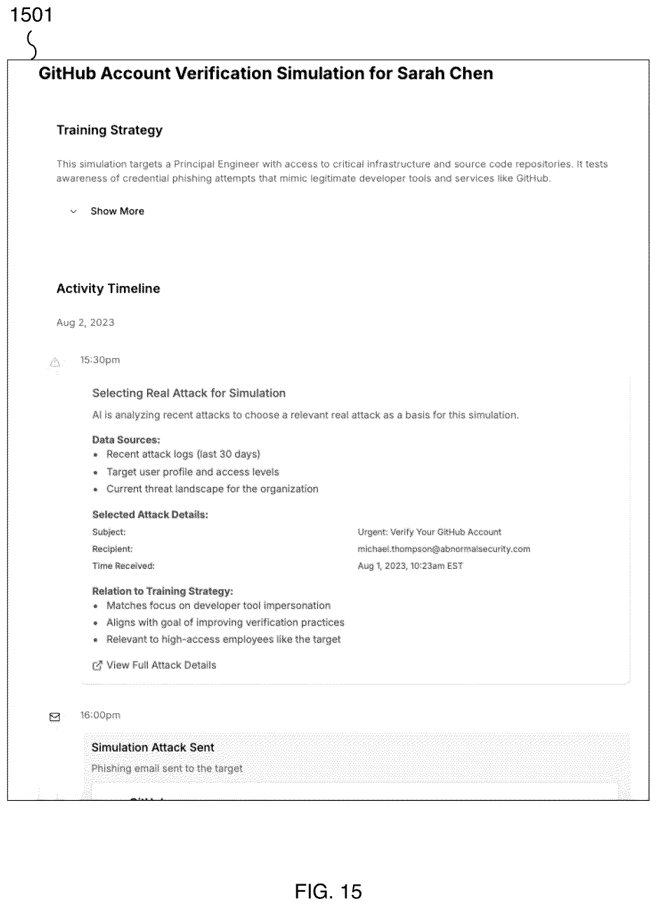

FIG. 15 is an example of a user interface timeline view for displaying security awareness training results. In the example shown, user interface timeline view 1501 shows the timeline associated with a security training threat simulation provided to a target recipient. The example shown is for a GitHub account verification simulation. User interface timeline view 1501 is a scrollable timeline that includes timestamps for relevant events during training, such as the selection of a real attack for simulation and when the simulation attack is sent. In various embodiments, the events are tracked by the security awareness training service and are provided to users such as the target recipient, security training personnel, and/or other users with the configured access permissions. As shown in FIG. 15, the timeline can include additional details of each event, such as details of the attack and the attack's relation to training strategy. In some embodiments, user interface timeline view 1501 is generated by security awareness training service 151 of FIG. 1 and/or security awareness training service 201 of FIG. 2 using the processes of FIGS. 3-6.

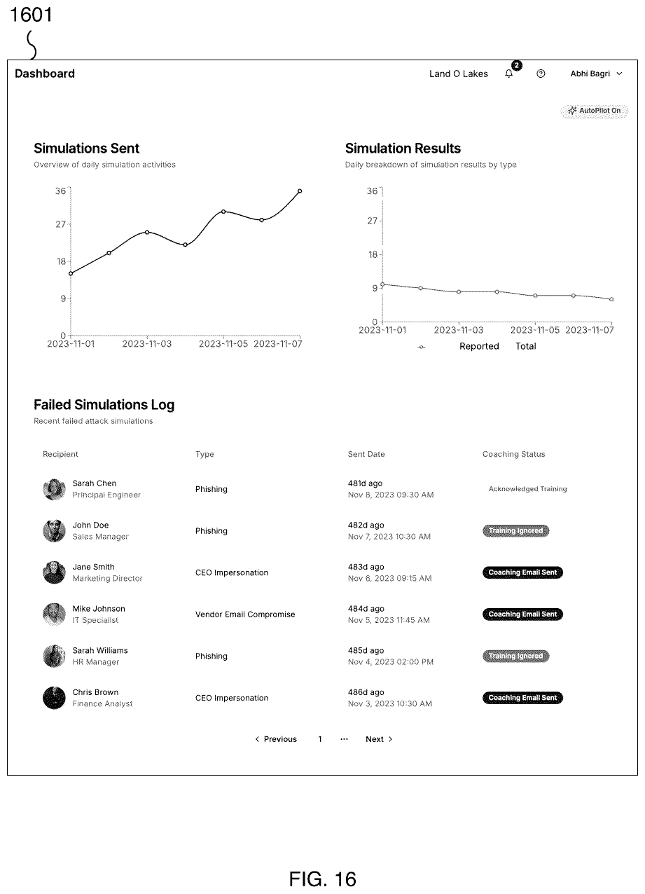

FIG. 16 is an example of a user interface dashboard view for displaying security awareness training results. In the example shown, user interface dashboard view 1601 shows simulation results data including simulations sent to targeted recipients and their corresponding training results. User interface dashboard view 1601 also includes data for failed simulations, among other training results data. As shown in the example of FIG. 16, the simulation data includes the target recipient, the attack type, the date sent, whether the coaching status of the provided simulation. Other training data that can be shown include the number of simulations or simulation tests sent to recipients, the percentage of simulations ignored, the percentage failed, and the percentage reported. For coaching status, the data can include that the sent training was acknowledged, that the training was ignored, and that a coaching email was sent. Other options can include the date training was completed, the percentage of recipients in progress with training, and the percentage of recipients enrolled in training. In various embodiments, user interface dashboard view 1601 can include additional training results data and can allow the viewer to interactively access or review additional details on training results. In some embodiments, user interface dashboard view 1601 is generated by security awareness training service 151 of FIG. 1 and/or security awareness training service 201 of FIG. 2 using the processes of FIGS. 3-6.

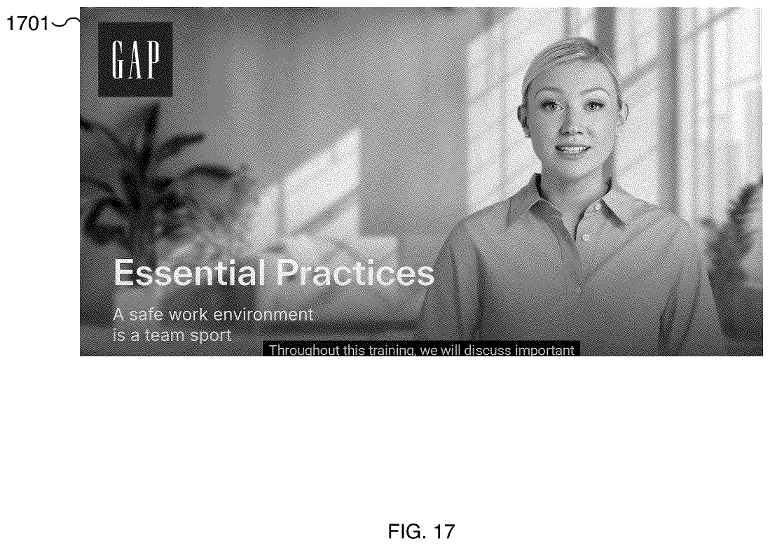

FIG. 17 is an example of a generated personalized security training video provided to a target recipient for security awareness training. In the example of FIG. 17, a single frame of personalized security training video 1701 is shown. The frame can correspond to one of multiple video segments that are combined to create the complete training video. In some embodiments, personalized security training video 1701 is generated using a security awareness training service based on the target recipient and other configuration parameters. For example, the narrator shown in personalized security training video 1701 can be artificial intelligence (AI) generated and based on an actual employee of the organization, such as the organization's chief security officer, the recipient's manager, or another configured narrator. Similarly, the voiceover generated for the video can match the configured narrator. As shown in the upper left corner of personalized security training video 1701, media assets such as an organization logo can be embedded within the generated video, providing customization to security video training. Similarly, the background of the video can be configured such as by providing personalized media assets or a descriptive prompt to a text-to-video generative machine learning model. In some embodiments, automatically selected default settings are used for configurable settings. In various embodiments, the tone of the voiceover is further configured and can match the desired tone of speech or personality of an organization. The generated video can further include generated or provided titles, subtitles, and captioning. In various embodiments, when provided to the target recipient, the recipient's interactions with personalized security training video 1701 are tracked including when the recipient completes viewing the entire video. Other aspects of the recipient's interaction with personalized security training video 1701, such as paused sections, areas where the recipient hovers, and replayed portions, among other engagement metrics, can also be tracked. In some embodiments, the video is configured such that no portion of the video can be skipped. In some embodiments, personalized security training video 1701 is generated by security awareness training service 151 of FIG. 1 and/or security awareness training service 201 of FIG. 2 using the processes of FIGS. 3-6 and/or FIG. 8.

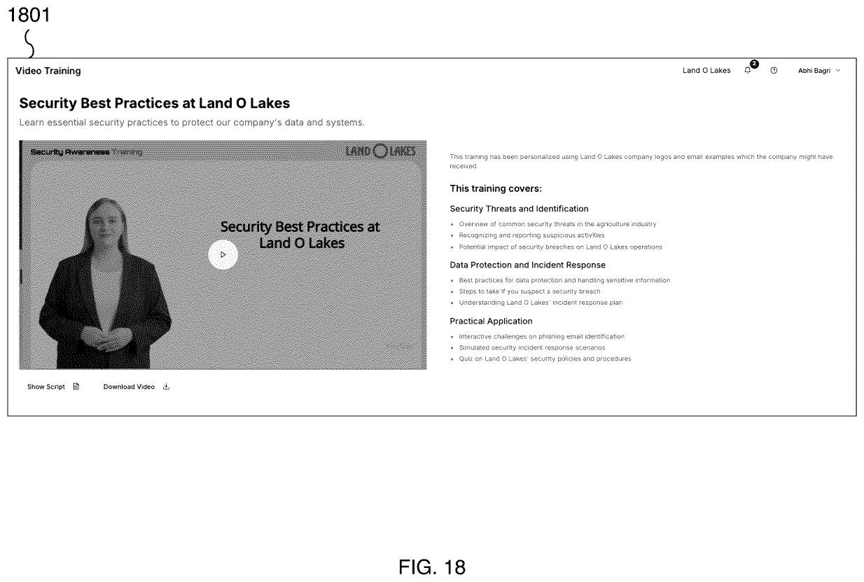

FIG. 18 is an example of a generated personalized security video training provided to a target recipient for security awareness training. In the example of FIG. 18, the user interface of generated personalized video training 1801 is shown. The video training includes both a generated personalized video and a descriptive overview of the training session. The user interface allows the user to watch the video, download the video, and show the script of the embedded video. In various embodiments, when provided to the target recipient, the recipient's interactions with generated personalized video training 1801 are tracked including when the recipient completes viewing the entire video, whether the recipient downloads the video, and/or whether the recipient views the video script. Other aspects of the recipient's interaction with generated personalized video training 1801, such as paused sections, areas where the recipient hovers, and replayed portions, among other engagement metrics, can also be tracked. In some embodiments, the video is configured such that no portion of the video can be skipped. In some embodiments, the personalized video of generated personalized video training 1801 is generated by security awareness training service 151 of FIG. 1 and/or security awareness training service 201 of FIG. 2 using the processes of FIGS. 3-6 and/or FIG. 8.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining information associated with a security test target recipient;
based on the obtained information, using a large language model to customize content of a security test for the security test target recipient;
providing the security test with the customized content to the security test target recipient;
tracking a recipient behavior to the security test; and
based on the recipient behavior, providing responsive content to the security test target recipient.

2. The method of claim 1, further comprising selecting a security simulation template from a plurality of security simulation templates, wherein the selected security simulation template is associated with a security threat scenario.

3. The method of claim 2, wherein the selected security simulation template is based on a message received by the security test target recipient and identified as a security threat.

4. The method of claim 2, wherein selecting the security simulation template from the plurality of security simulation templates includes prompting the large language model or a different large language model to select a template based on the security test target recipient.

5. The method of claim 2, wherein using the large language model to customize the content of the security test for the security test target recipient includes creating a generative artificial intelligence prompt for the large language model, wherein the generative artificial intelligence prompt references the selected security simulation template.

6. The method of claim 1, further comprising receiving from the security test target recipient a follow-up request based on the provided responsive content.

7. The method of claim 6, further comprising:
generating a follow-up response to the follow-up request; and
providing the generated follow-up response to the security test target recipient.

8. The method of claim 7, wherein generating the follow-up response to the follow-up request includes using the large language model to customize content of the follow-up response based on the follow-up request.

9. The method of claim 1, wherein the provided responsive content is a personalized video generated using a video generation machine learning model.

10. The method of claim 9, wherein the personalized video includes one or more provided personalized media assets.

11. The method of claim 9, wherein the personalized video is generated to have a specified tone of speech.

12. A system, comprising:
one or more processors; and
a memory coupled to the one or more processors, wherein the memory is configured to provide the one or more processors with instructions which when executed cause the one or more processors to:
obtain information associated with a security test target recipient;
based on the obtained information, use a large language model to customize content of a security test for the security test target recipient;
provide the security test with the customized content to the security test target recipient;
track a recipient behavior to the security test; and
based on the recipient behavior, provide responsive content to the security test target recipient.

13. The system of claim 12, wherein the memory is further configured to provide the one or more processors with instructions which when executed cause the one or more processors to: select a security simulation template from a plurality of security simulation templates, wherein the selected security simulation template is associated with a security threat scenario.

14. The system of claim 13, wherein the selected security simulation template is based on a message received by the security test target recipient and identified as a security threat.

15. The system of claim 13, wherein to select the security simulation template from the plurality of security simulation templates includes to prompt the large language model or a different large language model to select a template based on the security test target recipient.

16. The system of claim 13, wherein using the large language model to customize the content of the security test for the security test target recipient includes creating a generative artificial intelligence prompt for the large language model, wherein the generative artificial intelligence prompt references the selected security simulation template.

17. The system of claim 12, wherein the memory is further configured to provide the one or more processors with instructions which when executed cause the one or more processors to:
receive from the security test target recipient a follow-up request based on the provided responsive content;
generate a follow-up response to the follow-up request; and
provide the generated follow-up response to the security test target recipient.

18. The system of claim 12, wherein the provided responsive content is a personalized video generated using a video generation machine learning model.

19. The system of claim 18, wherein the personalized video is generated to have a specified tone of speech.

20. A computer program product, the computer program product being embodied in a non-transitory computer readable storage medium and comprising computer instructions for:
obtaining information associated with a security test target recipient;
based on the obtained information, using a large language model to customize content of a security test for the security test target recipient;
providing the security test with the customized content to the security test target recipient;
tracking a recipient behavior to the security test; and
based on the recipient behavior, providing responsive content to the security test target recipient.
